(19) United States
(12) Patent Application Publication
(10) Pub. No.: US 2021/0409980 A1
(43) Pub. Date: Dec. 30, 2021

(54) PRIORITIZING INCIDENTS IN A UTILITY SUPPLY NETWORK

(71) Applicant: SPATIALBUZZ LIMITED, Guildford (GB)

(72) Inventors: Andrew BLAKE, Guildford (GB); Michael SHANNON, Redhill (GB)

(73) Assignee: SPATIALBUZZ LIMITED, Guildford (GB)

(21) Appl. No.: 17/354,670

(22) Filed: Jun. 22, 2021

(30) Foreign Application Priority Data
Jun. 24, 2020 (GB) 2009678.0

(51) Int. Cl. H04W 24/04; H04L 12/24

(52) U.S. Cl. CPC H04W 24/04; H04L 41/5067; H04L 41/0609

(57) ABSTRACT

A computer-implemented method of determining a priority of an incident in a utility supply involves receiving an indication of the incident in the utility supply network, receiving subjective data relating to user perception of performance of the utility supply network and determining a priority of the incident based on the subjective data. Determining the priority may also involve using objective data about the performance of the utility supply network and information about known or planned outages.

### CROSS REFERENCE TO RELATED APPLICATION

The present disclosure claims priority to United Kingdom Patent Application No. 2009678.0, filed Jun. 24, 2020 and entitled “Prioritising Incidents in a Utility Supply Network,” the content of which is incorporated herein in its entirety.

### FIELD

The present disclosure relates to a method of determining a priority of an incident (such as a fault) in a utility supply network (such as a mobile communications network).

### BACKGROUND

Faults occur in utility supply networks, as in all other complex technical systems. In the context of a cellular, or mobile, network, such faults include the failure of hardware components in the base-stations of the mobile network, failures in other systems which are connected to multiple base-stations (for example, the radio network controller—RNC—in a 3G system, the loss of which results in the loss of operation of large sections of the network, such as, all node B base-stations connected to the RNC) and failures to switching and other more centralised functions, which again would impact multiple areas of the network simultaneously.

When such failures occur, it is important to identify them as quickly as possible, so that simple remote measures may be taken to alleviate the fault (for example, resetting a piece of network equipment) and/or so that a maintenance team can be dispatched to repair the fault and restore service to the customers of the network. It is equally, if not more, important to enable customers affected by the failure to be kept informed about the fact that a failure has occurred (hence relieving customer anxiety that their mobile device may be at fault) and also about the progress of a repair and the likely time at which service will be restored. This is increasingly important in keeping customers happy and reducing their likelihood of moving to another network operator due to a perception of poor service from their existing network operator.

One mechanism by which a network operator may be alerted to failures or issues on their network is by equipment alarms that are fitted to most items of network equipment. These equipment alarms indicate a range of major failures and more minor warnings. For example, a major failure alarm may occur if a base-station's RF output power drops to zero when it should be dealing with traffic (for example, during a busy part of the day), whereas a warning alarm may result from the output power being at a lower level than the power level to which it has been set (but where the power level has not dropped to zero).

Although an alarm or warning may indicate a fault that should be repaired, ideally as soon as possible, it is not typically realistic for network operators to deal with all alarms and warnings immediately. An operator's network will typically consist of tens of thousands of base stations and the network operator may be seeing thousands of alarms and warnings at any given point in time. The network operator does not have the resources to deal with all of these simultaneously and, in most cases, the network can continue to function adequately despite the presence of these many alarms, with any repair being scheduled for the next planned maintenance visit.

For example, the low output power discussed above may, nevertheless, be adequate to provide a satisfactory service to the users of the affected cell, in which case the network operator need only deal with the problem during the next planned maintenance visit, if at all. Similarly, a warning that a base-station mast-head power amplifier is running hotter than it ordinarily should or an RNC cabinet temperature is higher than normal is unlikely to cause immediate failure and can be repaired during the next planned maintenance visit.

It may also be the case that a fault occurs which does not have an associated alarm or warning. For example, extreme weather (wind) could cause the pointing angle of an antenna to change, thereby altering the coverage of the cell and reducing or removing coverage to some users, without causing any kind of alarm or warning.

So, while alarms and warnings are useful to the network operator, they are not sufficient by themselves to allow the network operator to manage its maintenance tasks efficiently. The network operator needs an additional mechanism to allow it to prioritize repairs and, indeed, decide whether a repair is even necessary.

At present, network operators rely upon a disparate array of systems for managing and reporting faults, planned network outages, progress updates for repairs which are underway and the identification and location of congestion events and other aspects which impact the customer's experience of a mobile operator's network. As a customer, however, all of these result in a single outcome: poor (or no) mobile service. Reporting the fact that such issues are known (or not, which may indicate a problem with the user's mobile device) and when they are likely to be resolved, is becoming increasingly important in the quest to retain customers and reduce customer ‘churn’ (customers moving from one network operator to another).

There is an issue of ‘confidence’ in regard to user-reported network issues—at what point should a network operator begin to take notice of, and act upon, user-reported problems in a particular part of the network? At present, a network operator is unlikely to take notice of two or three reports in a particular area, however these reports may be the start of a flood of such reports, at which point the operator has a large number of dissatisfied customers. A much better solution would be to deal with the problem early, if possible, and initiate a ‘repair’ (which could be a simple remote re-boot of a piece of equipment), before the trickle of complaints becomes a flood.

One option currently used to try and solve these issues involves monitoring and logging data indicating the performance of every base station in the network. This data can then be analysed to try to indirectly work out which base stations are impacting users the most (for example, by assuming that a low signal strength indicates unhappy users, or similar crude measures).

Logging this data is a huge task which absorbs a vast amount of computing resources, yet it still only provides a network-centric view of what is happening and not a customer-centric view. If this network data is available, it can be a useful resource in helping to determine that a fault may really exist, however as a stand-alone measure, it is poor in assessing the impact of any fault upon network users. No network will ever be perfect and operators typically aim for ‘good enough’, however what constitutes ‘good enough’ should be determined by the users and their experience of the network, not a set of automated measurements, no matter how comprehensive.

The network operator has to decide how best to deploy its maintenance resources whilst achieving the greatest level of satisfaction from the network's customers. The current means of undertaking this ranking of repairs usually relies upon crude measures, which may include:

1) the number of users typically served by a given cell—the higher the number of users, the higher the priority for repair;

2) the revenue generated by the cell—again, the higher the number, the higher the priority for repair; and

3) the status of the users covered by the cell—a higher than average number of key influencers, high-spending users or VIPs within a cell's curtilage, the higher the priority for repair.

Whilst this method works, to a degree, it makes assumptions about the numbers of users impacted and, crucially, about the user's perception of the failure. Taking an extreme example, if a site had failed and other nearby sites then took over serving the affected users and all of the users were only sending occasional text messages (and doing nothing else), then those users would probably notice little or no difference to their service. The local base transceiver station (BTS) which had failed, however, might still appear as a high priority to repair, perhaps due to the type of alarm generated or the number of users this BTS would typically serve. In reality, even if the site was not repaired for days or weeks, these text-message-only users would not notice and nor would they be dissatisfied customers. Conversely, a failed site with fewer but, for example, heavy data users, would lead to many more complaints and a very dissatisfied user base.

It would, therefore, be advantageous to find a better way to rank network faults by priority in order to prioritize network repairs.

### SUMMARY

According to a first aspect, there is provided a computer-implemented method of determining a priority of an incident in a utility supply network. The method comprises receiving an indication of the incident in the utility supply network and receiving subjective data relating to user perception of performance of the utility supply network. The method comprises determining a priority of the incident based on the subjective data.

By basing the priority of the incident on subjective data relating to user perception of performance of the utility supply network (such as the number of status checks on the performance of the utility supply network received from a cluster of users in a particular area or supplied by common network equipment), the network operator may be able to determine the extent to which the incident is actually affecting users, allowing the network operator to prioritize, for example, the repair of incidents which are having the greatest impact on its users.

The subjective data may be associated with a cluster of users associated with the incident. For example, the cluster of users associated with the incident may be based on users in a geographic area (such as a hexagonal or other shaped region) associated with the incident and/or users supplied by network equipment associated with the incident (such as a common piece of network equipment).

The subjective data may comprise status checks on the performance of the utility supply network by users of the cluster.

The priority of the incident may be based on the number of users in the cluster submitting status checks. The priority of the incident may be based on the absolute number of users in the cluster submitting status checks. Alternatively, the priority of the incident may be based on the number of users in the cluster submitting status checks as a proportion of the total number of users associated with the cluster.

The number of users associated with the cluster may be the number of users typically supplied by network equipment associated with the incident or the number of users supplied by the network equipment at the time of the incident.

The method may further comprise receiving outage data indicating a level of outage on the utility supply network. Determining the priority of the incident may be based on the number of users in the cluster submitting status checks and the level of outage given by the outage information.

The outage data may indicate a known outage on the utility supply network and the priority may be increased in response to the known outage.

The outage data may indicate no known outage on the utility supply network and the priority may be decreased in response to there being no known outage.

Determining the priority of the incident may comprise comparing the number of users in the cluster submitting status checks against a plurality of thresholds. The number of users in the cluster submitting status checks exceeding a given threshold of the plurality of thresholds may assign one of a plurality of priority levels to the incident.

The plurality of priority levels may comprise a priority level for urgent incidents and a priority level for incidents investigable during routine maintenance.

The method may further comprise modifying the priority of the incident based on accessibility of a site associated with the incident. Accessibility of a site may be based on physical constraints (for example, the site being remote or far from a maintenance depot, the site being at height such as on top of a tall tower, and/or the site being in a region where inclement weather is likely). Accessibility of a site may be based on access constraints (like site ownership and the requirements for access permissions and/or fees).

The priority may be determined by evaluating, using a decision-tree, one of more of: subjective data, objective data and outage data.

The method may further comprise receiving objective data relating to measurements of the performance of the utility supply network. The method may further comprise determining the priority of the incident based on the subjective data and the objective data. The subjective data may indicate that users of the network are unhappy with the performance of the network and the objective data may confirm that some form of disruption actually exists, of a sufficiently severe nature, that it warrants a particular priority being assigned to the incident. In other words, basing the priority on both the subjective data and the objective data confirms that the subjective data (such as the number of user status checks requested) is supported by objective data which indicates a severity of disruption exists, commensurate with the subjective data (user-initiated status checks).

The priority of the incident may be based on a level of disruption to the performance of the utility supply network indicated by the objective data.

The method may comprise adjusting the priority of the incident based on the objective data. For example, the priority of the incident may be decreased in response to the objective data indicating a lower level of disruption. The priority of the incident may be increased in response to the objective data indicating a higher level of disruption.

The level of disruption may be determined through comparison between the objective data and historical objective data. The historical objective data may be for a time of day corresponding with the time of day associated with the incident.

The priority of the incident may be modified based on the number and/or importance of users of the utility supply network predicted to be affected by the incident. For example, status checks by influencers or VIPs may results in the priority of the incident being increased.

The priority of the incident may be modified based on the number of items of network equipment disrupted by the incident, for example, the priority of the incident may be increased in response to the incident disrupting a plurality of network equipment.

The incident may be a fault, known problem or outage with the utility supply network or equipment connected to the utility supply network. The incident may be an alarm or warning associated with equipment connected to the utility supply network. The incident may be a maintenance event or an upgrade of equipment connected to the utility supply network. The incident may be a cluster of users requesting status checks on the performance of the utility supply network or submitting complaints about the performance of the utility supply network. The incident may be a network measurement-derived indication of a problem with the utility supply network.

The utility supply network may be a communications network, such as a mobile communications network. Measurements of the performance of the mobile communications network may comprise at least one of: signal strength received at a mobile device connected to the mobile communications network, transmitter output power, transmitted data rates, latency, voice quality, bit error rate, and SINAD.

According to a second aspect, there is provided a tool to determine a priority of an incident in a utility supply network. The tool comprises an input configured to receive an indication of the incident in the utility supply network and subjective data relating to user perception of performance of the utility supply network. The tool has a processor configured to determine a priority of the incident based on the subjective data.

The tool may be configured to carry out a method according to the first aspect.

According to a third aspect, there is provided a computer readable storage medium comprising instructions which when executed by a processor cause the processor to carry out a method according to the first aspect.

### BRIEF DESCRIPTION OF THE DRAWINGS

The subject matter shall now be described, by way of example only, with reference to the accompanying drawings in which:

FIG. 1 illustrates a system for collecting performance data about a communications network for use in identifying faults in the communications network;

FIG. 2 is a flowchart representing a method for ranking and prioritizing network faults for repair; and

FIG. 3 shows an example of an algorithm for assigning a priority to network faults.

### DETAILED DESCRIPTION

The present disclosure proposes a method of ranking network faults (at sites, RNCs, transmission links, etc.) and/or network alarms in order to prioritize the maintenance resources of a network operator towards geographic areas and faults which are most severely impacting users or the reputation of the network's brand (for example if a VIP or ‘influencer’ is being impacted).

Failed sites (or other network components or equipment alarms) may be ranked according to how many users undertook a ‘status check’, that is, used an app on their phone, or a web-site, in order to check if there were known service problems at their location. Such checks are an indication of user dissatisfaction with the service they are receiving, as users rarely make such checks if they are receiving a good service. Whilst this mechanism may appear to solve the problem of ranking network faults, there are a number of issues with it:

1. Users may be suffering congestion on the network which is unrelated to equipment failure, but will still undertake status checks.

2. Users may have experienced a small drop in performance, due to a failure in a local piece of network equipment, but are not suffering unduly. For example they may be experiencing a reduced, but still reasonable, data rate. Such users may well still undertake a status check, but would not be as unhappy as other users, elsewhere on the network, who had suffered a dramatic drop in data rate—the latter would be the higher priority for repair.

3. Specific types of user may be suffering problems, whereas other users may be unaffected. For example, heavy data users and gaming users would suffer if a latency-related problem occurred, whereas lighter data users and voice or text users would probably not notice a problem at all. Whether this situation constitutes a high priority would depend on the network operator's policies and any service level agreements with users which may vary between network operators. However at the very least, diagnostic data would be useful, here, in order to determine why these users were unhappy.

4. Network operators are currently suspicious of emerging numbers of status checks as an indication of problems at a site, until the number of such checks becomes overwhelming. There is a prevailing attitude that “people always complain” and that this is not necessarily an indication of a fault.

The method to be described herein solves these problems by using ‘subjective’ data (that is, status checks and other user-reported metrics) to prioritize network repairs. A network operator may verify that subjective user dissatisfaction, as evidenced by the number of status checks, is matched by a corresponding reduction in one or more objective measurements experienced by that same set of users and checked against any other nearby users (for example, connected to, or via, the same resource—BTS, RNC, transmission link, etc.). The objective data may be, for example, measurements taken by a user's mobile device of the service quality it is experiencing (for example, received signal strength, transmitter output power, received and transmitted data rates, latency, voice quality, bit error rate, signal-to-interference, noise and distortion (SINAD) and any other metric which the handset is capable of reporting).

The operator can then report back to the dissatisfied users, acknowledging that there is a fault. From the level of priority assigned to the repair, the operator can provide the user with an indication as to when it might be repaired (for example, sending a message to the user's mobile device or reporting via the app through which the user communicated their dissatisfaction).

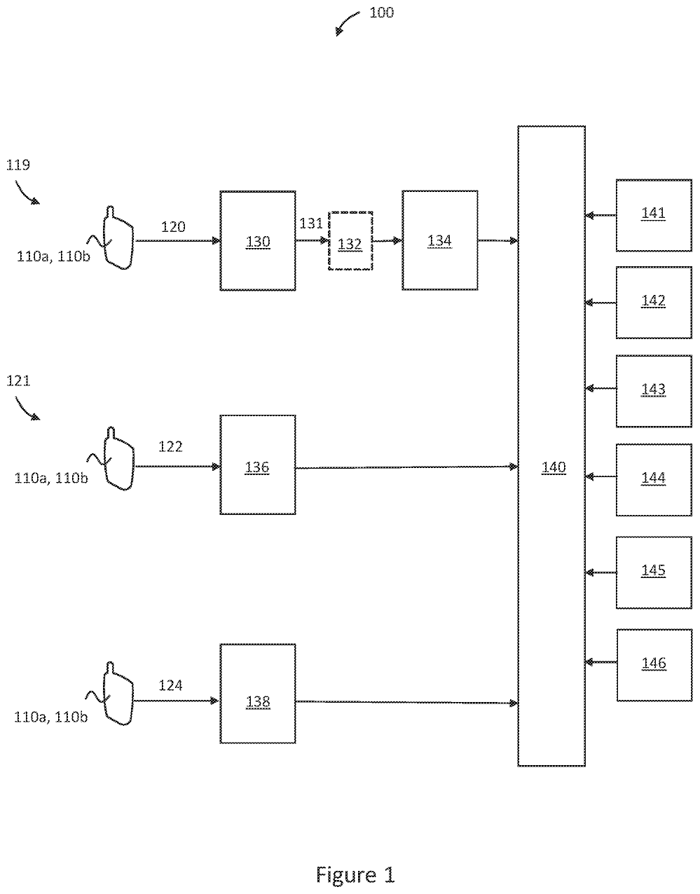

FIG. 1 illustrates an example of a system 100 that can be used to collect subjective data 124 and objective data 120, 122 relating to the performance of a communications network.

### Subjective Data 124

Subjective data 124 is user-generated data on the status or performance of the network perceived by the user of mobile devices 110a belonging to users reporting issues and mobile devices 110b belonging to other users nearby. Such subjective data 124 may be generated in a number of different ways, including:

Status checks—these are checks made by the user, typically using an app on their mobile device 110a, 110b that has been provided for the purpose by the network operator (the app typically has many other functions as well, such as providing the ability to access the user's bill, usage to date, coverage maps etc.). The user will typically undertake a status check when they are experiencing a problem with the communications network or when they are receiving a poorer service than they might expect. A status check typically involves pressing a virtual button in the app on the touch-screen of the mobile device 110a, 110b which sends a message to the network operator asking if there is any known problem on the communications network local to the user. If there is a known problem, an explanatory message will typically be sent to the user's mobile device 110a, 110b in response, acknowledging that there is a problem and perhaps indicating the nature of the problem and when it will be rectified. A status check can also be undertaken in a similar way using a web browser pointed to the operator's web site.

Feedback reports—these can either be reports voluntarily submitted by the user (for example, via the network operator's website) which are essentially complaints about the service the user is receiving, or reports elicited by the network operator sending out a survey to selected users. Such surveys could, for example, be targeted at users in an area where it is possible that a problem exists—where other local users have undertaken status checks, for example—and the network operator wants to understand other users' experiences.

Notification subscriptions—users can subscribe to notifications relating to when a network repair will be completed. A large number of such subscriptions (in a given area) could indicate that a large number of users are very unhappy about the service (or the lack of service) that they are currently receiving and are keen to know the moment it is restored to normal.

Calls to a call centre—users may call a customer service call centre to ask about the status of the network in their local area and to report problems with their service. A large number of calls from a particular area could indicate that there is a problem in that area.

There are, of course, many other possible ways in which a user could communicate their subjective view of the network (for example, via social media, either involving the operator or just complaining generally). It should be emphasised that all of the above reports (from users) are subjective—they relate to the user's perception of the network—and do not necessarily indicate that a fault exists, simply that the network, for whatever reason, does not meet the expectations of that particular user, in that particular location, at that particular time. Clearly, however, a large number of such reports, in a given area, at a given time, are potentially indicative of a network problem, even if that problem is simply ‘congestion’.

The subjective data 124 is collected by subjective data server 138. The subjective data 124 may be collected automatically (for example, from status checks performed on an app or website, or electronic feedback reports) or manually entered (for example, following a call with a call centre, the operator may manually enter the subjective data 124 into the subjective data server 138). The subjective data server 138 processes the subjective data 124 into a format suitable for database 140, before loading the subjective data 124 onto the database 140 where it is associated with an anonymised device identifier for the particular mobile device 110a, 110b, to allow the subjective data to later be associated with other relevant performance data for the particular mobile device 110a, 110b, such as the objective measurement data discussed below.

### Objective Data 120, 122

Objective data 120, 122 may include both measurements taken by mobile devices 110a belonging to users reporting issues and mobile devices 110b belonging to other users nearby. The measurements taken indicate the service quality the mobile devices 110a, 110b are experiencing (for example, received signal strength, transmitter output power, received and transmitted data rates, latency, voice quality, bit error rate, signal-to-interference, noise and distortion (SINAD) and any other metric which the mobile devices 110a, 110b are capable of reporting).

FIG. 1 illustrates two methods for collecting objective data 120, 122: batch-data collection 119 and live-data collection 121.

### Batch-data Collection

Batch-data collection 119 periodically (typically hourly) collects batch measurement data 120 from all mobile devices 110 connected to the communications network at measurements collection server 130. Given the need to collect batch measurement data 120 from all mobile devices 110 connected to the communications network, batch-data collection 119 is designed to handle very large volumes of data. For example, although batch measurement data 120 is typically collected from each mobile device 110a, 110b every hour, the exact collection times from each individual mobile device 110a, 110b may be randomly staggered to ensure that not all mobile devices 110 are trying to send their measurement data 120 simultaneously.

The batch measurement data 120 comprises measurements taken by a mobile device 110a, 110b of the network service quality it is experiencing (for example, received signal strength, transmitter output power, received and transmitted data rates, latency, voice quality, bit error rate, signal-to-interference, noise and distortion—SINAD—and any other metric which the mobile device 110a, 110b is capable of reporting).

Measurements collection server 130 generates a measurement report data file 131 for each set of batch measurement data 120 from a mobile device 110a, 110b. The measurement report data file 131 contains the batch measurement data 120 together with a timestamp indicating the time and date at which the batch measurement data 120 was collected and an identifier associated with the mobile device 110a, 110b (which is typically an anonymised version of the identifier provided by the mobile device 110a, 110b, to protect user privacy).

The measurement collection server 130 typically adds each batch measurement report data file 131 to a data queue 132 to await processing by the measurements batch processor 134.

The measurements batch processor 134 takes the batch measurement report data files 131 from the data queue 132 and essentially provides a translating/transformation process, converting the batch measurement report data files 131 and the data within them into the correct format to be stored in the database 140.

The data leaving the measurements batch processor 134 to enter the database 140 typically contains some or all of the following:

1) Anonymised identification—the digital identifier for the mobile device 110a, 110b from which the batch measurement data 120 originated is discarded and the anonymised device identifier for the particular mobile device 110a, 110b is attached instead. This allows the objective data collected in a current batch measurement to be associated with other objective and subjective data related to the particular mobile device 110a, 110b, such as objective data collected in an earlier or later batch, allowing the data from a particular mobile device 110a, 110b to be assessed over time while maintaining the privacy of the user of the mobile device 110a, 110b. Anyone interrogating the database 140 would be unable to identify the mobile device 110a, 110b or its user, and would only be able to identify that measurements have come from the same mobile device 110a, 110b or user.

2) A randomised identifier for the measurement report itself, to allow duplicates to be recognised and eliminated.

3) A location identifier indicating the network area, or a specific location within that area, in which the mobile device 110a, 110b was operating at the time the measurements were taken.

4) The location of the cell site which was serving the mobile device 110a, 110b at the time the measurements were taken.

5) The (compass) bearing of the mobile device 110a, 110b from that cell site.

6) The approximate distance of the mobile device 110a, 110b from the cell site's location.

The measurements batch processor 134 typically runs periodically (hence the requirement for the data queue 132), with an interval between initiating each run typically being around five minutes.

Although only a single measurement collection server 130 is shown in FIG. 1, it is possible to have multiple measurement collection servers 130, each feeding one or more batch processors 134.

### Live-data Collection

Live-data collection 121 collects live measurement data 122 from a mobile device 110a, 110b of the network service quality it is experiencing (for example, received signal strength, transmitter output power, received and transmitted data rates, latency, voice quality, bit error rate, signal-to-interference, noise and distortion—SINAD—and any other metric which the mobile device 110a, 110b is capable of reporting) at that point in time and/or the recent past (such as the network service quality the mobile device 110a, 110b experienced since a last scheduled upload of measurement data 122).

Live data collection 121 is triggered in response to the generation of subjective data 124. For example, a user performing a status check from their mobile device 110a causes live measurement data 122 to be obtained from the mobile device 110a which requested the status check.

Live measurement data 122 may also be requested from other mobile devices 110b which have not initiated a status check, but which happen to be local to an area of interest, either based for example upon the number of status checks in that area or a specific operator interest (such as at a stadium during an event). In both cases, the trigger for the collection of live measurement data 122 is subjective, i.e. a network user is, in their opinion, experiencing a poor or degraded level of service relative to that which they have experienced in the past or would reasonably expect to receive. This is inherently subjective, as different users will have differing opinions (or thresholds) as to what constitutes ‘poor’ or ‘degraded’. Collecting live measurement data 122 from other mobile devices 110b (typically nearby mobile devices or mobile devices similarly connected to the network, such as via the same base-station, RNC, transmission-link or other common network connection hardware) may aid in determining whether the issue which caused a user to initiate a status check is unique to that user (meaning that it may well be a problem with his/her mobile device 110a) or more general to the area (and if so, ascertain how widespread the issue might be). A more general experience of the problem (e.g. a low data rate) may well indicate that there is an issue with the communications network in that area.

Other triggers may also initiate live data collection 121, such as submitting web-based status requests or complaints. In this case, full live measurement data 122 may be collected from nearby mobile devices 110b while simpler data (such as network speed) may be collected from the web-based user or users. It is also possible to infer the identity of the connection type of the web-based user (i.e. Wi-Fi or cellular). In the case of a cellular connection, the network speed will indicate the user's network experience. If the user is connected over Wi-Fi, this may indicate that there is a catastrophic issue with the cellular network in that area (since the user needs to resort to Wi-Fi to request a status check). Measurement data from web-based users can be filtered out (and not used in subsequent fault analysis, for example) if the user is identified as not using the network operator's network when making the status check or not using it in the location about which the status check or coverage query is made.

Live data collection 121 typically comprises fewer servers (perhaps one-tenth of the number involved in batch-data collection 119), since far less live measurement data 122 is collected (or needs to be collected) than batch measurement data 120—live measurement data 122 only needs to be collected in response to a user-initiated status check, and only then within a given area or region, and there are few of these checks relative to the number of mobile devices 110 active on the communications network at a given point in time. Essentially, live measurement data 122 is only uploaded when it is interesting to do so, that is, there is an immediate reason to do so, and this uploading is undertaken immediately.

The live data server 136 enters the live measurement data 122 into the database 140 along with one or more of the following:

1) Anonymised identification—the digital identifier for the mobile device 110a, 110b from which the live measurement data 122 originated is discarded and the anonymised device identifier for the particular mobile device 110a, 110b is attached instead. This allows the objective data collected during the current live measurement to be associated with other objective and subjective data related to the particular mobile device 110a, 110b, allowing the data from a particular mobile device 110a, 110b to be assessed over time while maintaining the privacy of the user of the mobile device 110a, 110b. Anyone interrogating the database 140 would be unable to identify the mobile device 110a, 110b or its user, and would only be able to identify that measurements have come from the same mobile device 110a, 110b or user.

2) A randomised identifier for the live measurement data 122, to allow duplicates to be recognised and eliminated.

3) A location identifier indicating the network area, or a specific location within that area, in which the mobile device 110a, 110b was operating at the time the measurements were taken.

4) The location of the cell site which was serving the mobile device 110a, 110b at the time the measurements were taken.

5) The (compass) bearing of the mobile device 110a, 110b from that cell site.

6) The approximate distance of the mobile device 110a, 110b from the cell site's location.

### Database 140

The database 140 stores all of the measurement data (batch or live) in the form of records or tuples, within tables, in its structure. The database is typically an off-the-shelf product (such as Oracle, Postgres and the like) which is configured for this specific application (i.e. that of storing, and allowing access to, data collected from individual mobile devices 110). It can be accessed by the network operator directly or by other systems owned, managed or used by the network operator.

The database may also store data from a range of other pertinent data sources to aid in fault diagnosis, such as:

1) Data 141 relating to network change requests (requests for changes to the network configuration, such as the position or pointing angle of one or more antennas, the installation or de-commissioning of a base-station, etc.) and/or planned maintenance operations. This can help to inform decisions regarding whether a network change may be the root cause of an increase in the number of status checks locally to the change or if they may simply be as a result of a planned local outage in the network for maintenance or upgrade purposes.

2) Data 142 relating to ‘trouble tickets’ and/or known incidents on the network. These are incidents or problems of which the network operator is already aware and which may or may not be being dealt with already. Such information can be communicated to the users (e.g. in response to a status check), as appropriate.

3) Data 143 relating to network configuration information, such as cell-site locations, RNC/BSC parents and connectivity, antenna pointing angles, transmit power levels, etc. This information can be used, for example, to determine from which nearby mobile devices 110b measurement data should be requested, in the event of one or more local users initiating a status check.

4) Data 144 relating to network alarms. This can be used to correlate status checks and (poor) measurement data with known alarm conditions and, potentially, thereby raise their status within the maintenance hierarchy.

5) Data 145 relating to network performance characteristics, such as the amount of traffic being handled by each cell and the availability of each cell.

6) Data 146 from a network planning tool, including the designed network topology (which may not necessarily exactly match the network as deployed). This database will contain coverage maps and coverage predictions and may be used to assess whether the reported issue stems simply from the fact that the user is outside of the designed network coverage area.

Data 143, 145 and 146 provide the basis for a root-cause analysis to be undertaken, in order to identify the location (within the network hierarchy) of the faulty element.

### Combining Subjective Data 124 and Objective Data 120, 122

Since data in the database 140 is associated with an (anonymised) identifier for each mobile device 110a, 110b, subjective data 124 based on status checks and other information provided by the user of the mobile device 110a, 110b can be associated with objective data 120, 122 (batch and/or live measurement data) from the same mobile device 110a, 110b.

For example, if a user requests a status check from the network operator's app running on mobile device 110a, data relating to the status check will be stored on the database 140 with an anonymised identifier associated with mobile device 110a. Simultaneously, or soon after, live measurement data 122 will be requested from mobile device 110a, either by the live data server 136 or the app itself, and this live measurement data 122 will also be assigned to the same anonymised identifier associated with mobile device 110a.

In this way, the subjective data 124 and objective data 120, 122 may be combined when the database is queried to form a richer and more powerful resource to assist the network operator in identifying and diagnosing faults.

Each of the blocks of FIG. 1 could be implemented by a physically separate piece of hardware (such as a computer, server, hard disk storage unit or other item of electronic hardware), or some functions could be combined into a single piece of hardware (e.g. the measurement collection server 130, data queue 132 and measurements batch processor 134). It is also possible that some or all of these hardware items could be virtualized and be assigned to disparate hardware elements by a third-party service provider, such as a cloud computing services provider. In this case, a ‘server’ could actually be a virtual server, with tasks executed and spread across a number of physical hardware devices, potentially in different physical locations. In all of these physical hardware configurations, however, the main elements shown will be present, either physically/individually, or in varying degrees of virtualisation.

The system of FIG. 1 has the ability to scale as needed, that is, it is straightforward to add more computing resources as required, depending upon the volume of reports it is receiving. This may well increase over time as more customers are encouraged to sign-up to use the operator's service-reporting/billing app. The system could be implemented on a cloud computing platform to facilitate scaling.

Whilst the architecture shown in FIG. 1 may be used in conjunction with the present disclosure, it is important also to understand that a different architecture, for example one which utilises the network measurement reports often already collected by the base-stations, RNCs and other network infrastructure, may equally be used with the method. These measurement reports collate similar information to that discussed above (e.g. signal strengths, bit-error rates, etc.) however the data collected shows the network from the infrastructure's perspective and not the user's perspective and hence is sub-optimal. All references to ‘objective’ data, herein, should, however, be read as being able to be either user-device derived measurement data or network-derived measurement data.

### Prioritizing Network Faults Using Subjective and Objective Data

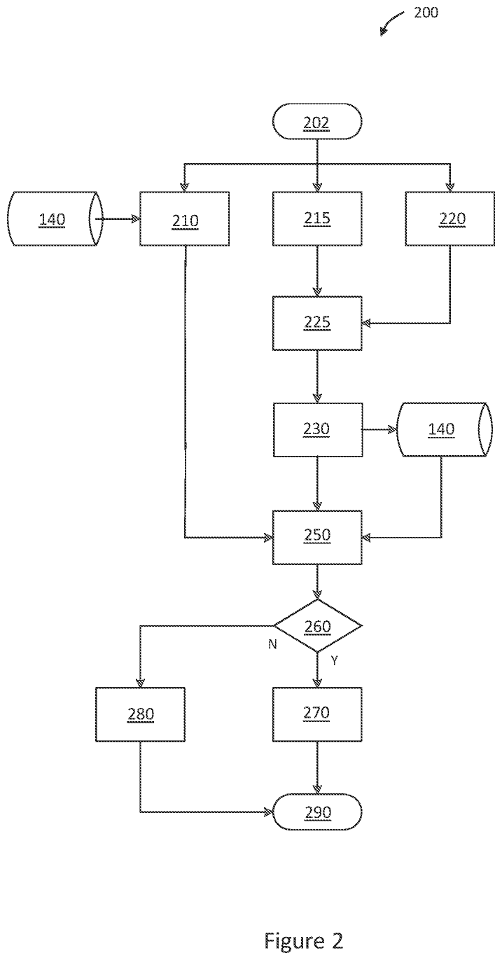

FIG. 2 shows a flowchart representing a method 200 for determining a priority of network faults so that they can be prioritized for repair.

The method 200 begins at step 202 and then moves to steps 210, 215 and 220 in parallel (although step 210 could occur at any point prior to step 250). Step 210 receives a list of ‘trouble tickets’ and known (planned) outages from a database, such as database 140.

‘Trouble tickets’ (which may also be referred to as ‘incidents’) are known incidents or issues on the network and may include alarms, scheduled maintenance tasks or outages, scheduled upgrades to the network equipment, or sites, ‘clusters’ of user reports of problems (such as clusters of status check requests undertaken by users of the network), network measurement-derived indications of a network problem or any other known (confirmed) or possible network issue of which the network operator is aware.

Step 210 also appends these known incidents (whether real or yet to be confirmed) with a geographic tag and optionally also a connectivity tag, if either or both tags are not already present in the database 140.

A geographic tag may include a latitude/longitude location of the resource or resources to which the alarm applies (e.g. a base-station), an address, area or region within which the resource lies (such as a pre-determined or calculated ‘hexagon’ region described in UK patent publication 2,577,758 A).

A connectivity tag may provide an indication of which other network elements are connected to the network element from which an alarm originates. For example, if the network element (which indicates an alarm) is a transmission link, the associated connectivity tag may include the downstream network elements which may be impacted by a fault on that transmission link (which may include one or more base-stations, RNCs etc.).

Step 215 receives objective data 120, 122 from the mobile device(s) 110a, 110b or the network. As discussed above, this may consist of measurement data derived from one or more mobile devices 110a, 110b, either through periodic (batch') transmissions or specifically (network) requested downloads or it may consist of network-derived measurements, or both.

Step 220 receives the subjective data 124 from users (via their mobile devices 110a or otherwise) indicating the possible presence of a fault or a poorer level of service than expected. For example, the number of status check requests in a given period, for example a (rolling) 4 hour period.

The objective data 120, 122 from step 215 and the subjective data 124 from step 220 are combined at step 225. This combining involves associating the objective data 120, 122 received in step 215 with the subjective data 124 received in step 220 on a device-by-device or area-by-area basis.

In a device-by-device case, for example, if user A provides subjective data 124, for example, by requesting a status check on the network, the subjective data 124 will typically be accompanied by objective data 120, 122 being collected from their mobile device 110a (either automatically as a part of the ‘status check’ process/app or elicited by the network from their mobile device 110a subsequent to the initiation of the ‘status check’ by the user). The subjective data 124 from user A will then be associated with (e.g. tagged with the same anonymised user identity in database 140 as) the objective data 120, 122 derived from their mobile device 110a or derived from the network whilst it is in communication with their mobile device 110a.

In an area-by-area case, objective data 120, 122 derived from mobile devices 110b in the same geographic area as the mobile device 110a of user A may also, in step 225, be associated with the subjective data 124 (for example, status check) of mobile device 110a belonging to user A. This association may be by means of appending a geographic identifier or tag to both the objective data 120, 122 and corresponding subjective data 124. The geographic identifier or tag may identify the hexagonal region within which both mobile devices 110a and 110b were located at the time the objective data 120, 122 was collected.

The method then moves on to step 230, in which the associated objective data 120, 122 and subjective data 124, formed in step 225, are stored in a database, such as database 140. This step typically utilises an ETL process (extract, transform and load) which essentially extracts the pertinent objective data 120, 122 and subjective data 124 from the reports, transforms the data into a format appropriate for use with the chosen form (or manufacturer) of database 140 and then loads the transformed data into the database 140 (e.g. into records or tuples in the relevant table(s) within the database structure).

The method then moves on to step 250 in which the network locations/resources (e.g. cell-sites, RNCs, transmission links, etc.) corresponding to the incident data received by the method in step 210 are assigned a priority based on the subjective data 124.

Broadly-speaking, the larger the number of user reports of problems (such as the number of status check requests) in a particular geographic area (such as a specific hexagonal region), the higher the priority of the incident. The priority may be based on the absolute number of user reports (such as status checks requested) in a particular geographical area (such as the specific hexagonal region), or the priority may be based on the number of user reports (such as status checks requested) as a proportion of the number of current users of the network in the particular geographic area (such as the specific hexagonal region) or the typical number of users expected in the particular geographic area (such as the specific hexagonal region) at the time in question.

For example, in a geographic area containing 200 users, with 10 status checks requested in a rolling 4 hour period, the number of status check requests could simply be stated as the absolute number, that is, 10. Alternatively, the number of status check requests could be stated in terms of the proportion of users in the geographic area making a status check request within the period, that is, 5%. Basing the priority on the proportion of users experiencing an issue allows the network operator to gauge the severity of the problem—if 50% of users are having issues, even though the absolute number may be smaller than with other live faults, it is clear that this particular fault may be severe. Alternatively, the network operator may choose to base the priority on the absolute number of affected users, simply because more customers are impacted and a larger number of unhappy users will be satisfied with a single repair. Both are valid approaches.

The priority of an incident may also be influenced by the types of users making status checks. For example, a smaller number of status checks by influencers or VIPs may result in a higher priority being assigned to the incident than a larger number of reports from ordinary customers of the network.

The method next moves to step 260 in which a check is made to ensure that the subjective data 124 derived from the user reports (such as status check requests) is backed up by the objective data 120, 122. That is, whether the objective data 120, 122 confirms that some form of disruption exists, of a sufficiently severe nature, that it warrants the priority assigned to the incident in step 250. In essence, this step asks the question (for each incident): are the user reports of problems (such as the number of user status checks requested) supported by objective data 120, 122 which indicates a severity of disruption exists, commensurate with the number of reports (user-initiated status checks) being made?

There are a number of possible scenarios:

1. A minor incident exists (for example, a power supply which is under-voltage or a transmitter which is low on output power), together with a notable number of user reports concerning the performance of the network in the same geographic area (or serving the same geographic area) as the equipment which is registering an issue. If the objective data 120, 122 from local mobile devices 110a, 110b (including those of the reporting users) shows little or no disruption (degradation) in the radio environment, when compared to a comparable period on an earlier day or days, then the priority of the issue provided in step 250 may be demoted, in step 280. If, on the other hand, the objective data 120, 122 supports the likelihood of a more severe disruption occurring, then the priority may be maintained, or even promoted in step 270. In both cases, the method then ends at step 290, although it will be re-run regularly (anything from continuously to every few minutes being likely). In this scenario, where the objective data 120, 122 does not support the subjective assessment, the real issue (causing the large number of user reports) may be congestion, with the presence of an alarm, for example, being merely coincidental.

2. A minor incident exists (as in scenario 1), together with a modest number of user reports concerning the performance of the network in the same area (or serving the same area) as the equipment which is registering an incident. In this case, the initial ranking, from step 250, is likely to be low (but probably far from the bottom of the list, since at least some user-initiated complaints exist—the impact of many incidents will go unnoticed by users). If, again, the objective data 120, 122 from local mobile devices 110a, 110b (including those of the reporting users) shows little or no disruption (degradation) in the radio environment, when compared to a comparable period on an earlier day or days, then the (low) ranking of the incident or issue provided in step 250 is likely to be maintained in step 270. In other words, a modest ranking is supported by the objective data 120, 122.

It is possible, however, that the objective data 120, 122 from local mobile devices 110a, 110b (including those of the reporting users) shows a severe disruption (degradation) in the radio environment, when compared to a comparable period on an earlier day or days. But, the time of day being associated with few network users in the geographic location may mean that the low priority of the incident assigned in step 250 may be increased in anticipation of the fact that when other users return (or wake up) the impact on users could become more severe.

In this scenario the priority may be increased in step 270, based on the proportion of current users registering a complaint (as discussed above). For example, during the day, there may typically be 50 active users in a particular geographic area, but there may only be 5 users active at the time of the incident due to the time of day. As a result, poor service reports from a relatively small number of users (such as 3 users) may trigger an increase in the priority because a high proportion of active users are reporting a problem. In contrast, such a small number of users would not warrant a priority increase at a different time of day when more users are active in the geographic area (that is, the priority will be higher when 3 users out of 5 users (60%) report an incident at night than had 3 users out of 50 users (6%) reported an incident during the day).

In both cases, the method then ends at step 290, although it will again be re-run regularly.

3. A major incident exists, but with few or no user reports of problems (for example, few or no status check requests). Similarly to scenario 2, the lack of user reports of problems may be due to the time of day (or night), with similar decisions being made in step 260 or 270 based upon the proportion of the total active users in the geographic area. If, in step 260, the objective data 120, 122 backs up the few user reports by confirming there is a problem, then a high priority may be assigned in step 270 (or maintained if a user-proportionate priority measure is used in step 250). Note that a relatively rich set of measurement data 120, 122 may be available, despite the lack of active users, since measurements may be elicited (and will continue to be provided in periodic batches) by inactive mobile devices 110a, 110b which are still switched on (for example, while its user is asleep).

If, on the other hand, there are a large number of active users of the resource in question (for example, cell site, RNC, transmission link, etc.), then the low priority assigned based on the few user-initiated status-check requests may be maintained in step 270, despite the presence of objective data 120, 122 which shows that there is some notable justification for the few user-initiated status-check requests. Indeed, it is even possible that the priority may be reduced further in step 280 due to the relatively small number of users impacted compared with what might be expected, given the user-base and alarm type.

The system is, effectively, taking the view that if the service quality is still sufficient to satisfy the vast majority of users (despite the presence of an obvious issue), then higher priority should be given to repairs which are impacting a greater proportion (or simply a larger number) of users, to the point where they complain. This may not mean that the lower-priority issue will not be attended to, just that it may not be attended to as quickly.

Again the method then ends at step 290, although it will be re-run regularly.

4. A major incident exists, with a large number of reports of problems (such as a large number of status check requests) by users (whether in absolute numbers or proportionately to the number of active users). In this case, strong support from the objective data 120, 122 would maintain or increase the (probably already high) priority of the incident in step 270, whereas weak support from the objective data 120, 122 might still lead to a significant reduction in priority in step 280, since whilst the user-impact is high, the incident and, indeed, the network hardware, may not be to blame. For example, the problem may be caused by network congestion or a temporary coverage issue (e.g. a bus or lorry blocking the signal, in the case of a small, e.g. city-centre, street-level, cell).

As above, the method then ends at step 290, and will be re-run regularly.

5. No incident exists, but a known (planned) outage, which could potentially affect the level of service provided in a given geographic area, is associated with a number of user-reports of problems within that geographic area. As in scenario 4, strong support from the objective data 120, 122 would maintain, or could increase, the priority of the outage in step 270, whereas weak support might still lead to a demotion in the priority in step 280, since whilst the user-impact may be high, the objective data 120, 122 may suggest that the outage may not be to blame.

Again, the method then ends at step 290, and will be re-run regularly.

### Prioritizing Network Faults Using Subjective Data and Outage Information

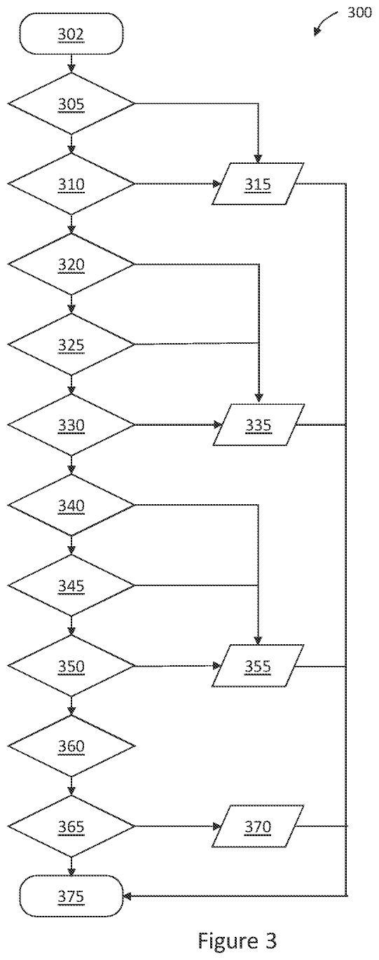

FIG. 3 shows an example of an algorithm 300 that could be used to assign a priority to network faults based on subjective data in the form of the number of user status check requests and outage information.

The algorithm 300 receives from one or more databases (such as database 140) information about one or more of: network change requests and/or planned maintenance operations; and ‘trouble tickets’ and/or known incidents on the network.

The algorithm 300 assigns user-reported issues into one of a number of priority levels, which may include issues without a corresponding incident. For example, planned maintenance outages may not have a corresponding incident since the network resource in question may be operating normally; the maintenance visit may simply be due to an upgrade or a scheduled physical inspection and test.

Essentially the algorithm 300 operates as a decision-tree with a sequence of tests. Each test is either passed (leading to the corresponding priority-level being chosen) or failed (leading to the next test in the sequence being tried).

The algorithm 300 begins at step 302 and moves on to step 305, in which a test is performed to ascertain if a given network location (i.e. site/premises/resource) has a known multi-site failure (MSF) which is defined as a failure (which may be a single-point failure) that impacts multiple sites. Examples of such failures could include the failure of an RNC (which connects to multiple BTSs) or a transmission link (which again will typically serve multiple BTSs, perhaps in a daisy-chain—if the first part of the transmission link fails, then all BTSs in the chain will be deprived of connectivity).

If the network location does exhibit a MSF, then the method moves to step 315 in which the incident(s) is/are assigned the highest priority (Priority 1) and hence are moved to the top of the repairs/maintenance ranking. Having assigned a priority, the method will then end at step 375.

If, in step 305, an MSF outage is not known, then the method moves on to step 310 in which a further test is performed to ascertain if the number of status checks equals or exceeds a first fixed threshold TH1 (where TH1 may be 20, for example). If this threshold is met or exceeded, again the method moves to step 315 in which the incident(s) is/are assigned the highest priority (Priority 1) and hence are also moved to the top of the repairs/maintenance ranking. Having assigned a priority, the method will then end at step 375.

If, in step 310, threshold TH1 is not exceeded, then the method moves on to step 320 in which a further test is performed to ascertain if the number of status checks equals or exceeds a second fixed threshold TH2 which is lower than the first fixed threshold TH1 (for example, TH2 may be 10) OR if the network location has one or more planned outages at that time. If this threshold is met or exceeded OR the location has planned outages, then the method moves to step 335 in which the incident(s) is/are assigned the second-highest priority (Priority 2) and dealt with accordingly in the ranking system and by the repairs/maintenance team. Having assigned a priority, the method will then end at step 375.

If, in step 320, threshold TH2 is not exceeded, then the method moves on to step 325 in which a further test is performed to ascertain if the number of status checks equals or exceeds a third fixed threshold TH3 (where TH3 may also be 10, for example, or may be a higher or lower number less than TH2) AND the network location has no planned outages at that time. If this threshold is met or exceeded AND the location has no planned outages, then the method again moves to step 335 in which the incident(s) is/are assigned the second-highest priority (Priority 2) and dealt with accordingly in the ranking system and by the repairs/maintenance team. Having assigned a priority, the method will then end at step 375.

If, in step 325, threshold TH3 is not exceeded, then the method moves on to step 330 in which a further test is performed to ascertain if the number of status checks equals or exceeds a fourth fixed threshold TH4 (where TH4 may also be 10, for example, or may be a higher or lower number less than TH3) AND the network location has only unplanned or partial outages at that time. If this threshold is met or exceeded AND the location has only unplanned or partial outages, then the method again moves to step 335 in which the incident(s) is/are assigned the second-highest priority (Priority 2) and dealt with accordingly in the ranking system and by the repairs/maintenance team. Having assigned a priority, the method will then end at step 375.

If, in step 330, threshold TH4 is not exceeded, then the method moves on to step 340 in which a further test is performed to ascertain if the number of status checks equals or exceeds a fifth fixed threshold TH5 (where TH5 may be 5, for example, or may be a higher or lower number less than TH4) AND the network location has no known outages at that time. If this threshold is met or exceeded AND the location has no known outages, then the method moves to step 355 in which the incident(s) is/are assigned the third-highest priority (Priority 3) and dealt with accordingly in the ranking system and by the repairs/maintenance team. Having assigned a priority, the method will then end at step 375.

If, in step 340, threshold TH5 is not exceeded, then the method moves on to step 345 in which a further test is performed to ascertain if the number of status checks equals or exceeds a sixth fixed threshold TH6 (where TH6 may also be 5, for example, or may be a higher or lower number less than TH5) AND the network location has only planned or partial outages at that time. If this threshold is met or exceeded AND the location has only planned or partial outages, then the method moves to step 355 in which the incident(s) is/are assigned the third- highest priority (Priority 3) and dealt with accordingly in the ranking system and by the repairs/maintenance team. Having assigned a priority, the method will then end at step 375.

If, in step 345, threshold TH6 is not exceeded, then the method moves on to step 350 in which a further test is performed to ascertain if the network location has only un-planned outages at that time. If the network location has only un-planned outages then the method moves to step 355 in which the incident(s) is/are assigned the third-highest priority (Priority 3) and dealt with accordingly in the ranking system and by the repairs/maintenance team. Having assigned a priority, the method will then end at step 375.

If, in step 350, the network location does not have purely un-planned outages, then the method moves on to step 360 in which a further test is performed to ascertain if the network location has no known outages at that time. If the network location has no known outages then the method moves to step 370 in which the incident(s) is/are assigned the fourth-highest priority (Priority 4) and dealt with accordingly in the ranking system and by the repairs/maintenance team. Having assigned a priority, the method will then end at step 375.

Finally, if, in step 360, the network location does not have no known outages, then the method moves on to step 365 in which a further test is performed to ascertain if the network location has either planned or un-planned outages at that time. If the network location has either planned or un-planned outages then the method moves to step 370 in which the incident(s) is/are assigned the fourth-highest priority (Priority 4) and dealt with accordingly in the ranking system and by the repairs/maintenance team. Having assigned a priority, the method will then end at step 375.

If the test in step 365 fails, then then method ends at step 375 without assigning a specific priority.

The algorithm example in FIG. 3 has been described as performing ten tests (305, 310, 320, 325, 330, 340, 345, 350, 360, and 365) assigning four priority levels (315, 335, 355, and 370). However, this is merely an example. The algorithm may perform N tests in order to assign n priority levels, where N>=n and both N and n are integers greater than or equal to 2. For example, each of the ten tests may assign anywhere from two priority levels, all the way up to 10 priority levels where each test assigns its own individual priority level.

The number of priority levels is selected by the network operator, for example, based on their operational requirements and available resources. For example, some operators may assign only two priority levels: “Priority 1: urgent” and “Priority 2: schedule for next regular maintenance visit”. However, most network operators will assign more priority levels to allow the network operator to better allocate resources. For example, at quiet times, a network operator may be able to deal with even low priority tasks, whereas at busier times, the network operator may need to finely ration which tasks are dealt with. Having finer resolution priority levels makes it easier for the network operator to allocate resources. For example, in the case of assigning only two priority levels, the network operator may have the resources to deal with all Priority 1 tasks but only some Priority 2 task—how should the network operator choose which Priority 2 tasks to undertake? If, however there were more priority levels (for example, the Priority 1 tasks were split into Priority 1a and Priority 1b and likewise Priority 2 tasks were split into Priority 2a and 2b), then the network operator could allocate resources to four priority levels: Priority 1a, Priority 1b, Priority 2a and Priority 2b.

A priority level may be assigned or modified based on site-dependent considerations. For example, based on the accessibility of the site at which faulty network equipment is installed. Sites may fall within a number of different categories, such as:

Easily-accessible sites (such as sites which the network operator owns and which require no special access permissions, for example, the site is not on top of a building which the operator does not own, like a city-centre office-block).

Easily-accessibly sites requiring access permissions (possibly incurring an access cost/fee).

Easily-accessible but remote site (for example, on a hillside in a very sparsely-populated rural area, many miles from the nearest operations hub, but with no access permission issues).

Challenging to access (remote, tall tower, inclement weather likely—such as a mountainous area in winter).

The difficulty (and associated cost) of accessing the site may influence the priority level allocated to an incident, or the priority level assigned by the algorithm (such as algorithm 300) may be adjusted by the network operator based on the site-dependent considerations. In other words, if the algorithm assigns ‘Priority 1’, but the site will be expensive to visit, then the network operator may make a judgement to lower the priority on a case-by-case basis (for example, making the “1a” vs “1b” split discussed above or even demoting it further to a lower priority level such as Priority 2, 3 or 4). In doing this, the network operator makes a judgement on whether potentially losing a few customers can be justified relative to the likely site-visit cost.

Whilst the algorithm 300 has been described above in terms of using user status checks as a metric for prioritizing repairs, in practice a number of other factors will typically be included in any prioritization decision, for example:

1. The number of typical users served by a given cell (e.g. the typical number of subscribers attached to that cell, per day)—the higher the number of users, potentially the higher the priority for the repair.

2. The revenue generated by the cell—again, the higher the number, potentially the higher the priority.

3. The status/marketing segment of the users covered by the cell—a higher than average number of key influencers, high-spending users or VIPs within a cell's curtilage, the higher the priority of a repair (likewise if most customers are on pay-as-you-go tariffs, then that site may well get a lower priority for repair).

4. Whether or not there is a known issue at that particular site (or affecting that site).

5. The most popular sites, based on measurement reports derived from mobile devices 110a, 110b.

6. Geographic data about where important locations lie in relation to the cells (for example) in which the important location(s) lies. For example, an alarm at a cell-site covering the houses of parliament, a major BBC site (where bad publicity may ensue) or the network operator's corporate headquarters could be prioritized, even though few of the other normal criteria may have been met.

Clearly, different tests could be applied, a wider or smaller range of priorities could be used and other inputs could be included within the decision-making process (e.g. data from a network planning tool concerning the predicted coverage of a resource, such as a BTS, which is undergoing maintenance). In the latter case, this could indicate if the user-complaints really do (all) correspond to the resource in question and do not just happen to be nearby to the resource.

A further and important aspect of the system is to send messages to users (who have undertaken a status check and/or signed up to receive network fault report updates), to update them on the priority assigned to an incident.

For example, if an incident is given a higher priority, then the message which is sent to users of the network may include statements indicating that the fault is known, has been diagnosed and will be repaired by a specified time. If, on the other hand, the alarm is assigned a lower priority, then the message may reflect this by indicating that a possible fault is under investigation and that further updates will be provided in due course, etc., i.e. a lower-key' message, reassuring users that work of some sort is underway, but setting their expectations at a lower level regarding when a resolution to the problem might be forthcoming. There are clearly many types of message which can be provided, based upon the ranking of the alarm within the hierarchy.

### Application to Other Utility Supply Networks

It is possible to apply the present disclosure described above to diagnose faults in all kinds of communications networks, including 2G, 3G, 4G, 5G, PMR/SMR, Wi-Fi, etc.

Equally, it is possible to apply the present disclosure to a fixed-line data network, such as a ‘broadband’ internet network (e.g. using DSL, fibre optics or similar). In such a case, the present disclosure could be used to diagnose faults in roadside cabinets containing switching or routing equipment or any other equipment which serves a number of users in a given locality. For example, a user connected to the same roadside cabinet who was experiencing poor service could perform a service check (e.g. using a device connected to a cellular data service) and data about the service could be measured (such as upload and download speeds) from the user and other users connected to the same roadside cabinet. The measurements could be compared to historical measurements from the same, or similar, cabinets where the historical fault has been identified in order to diagnose the present fault.

Although the present disclosure has been described in the context of the utility supply network being a communications network, the skilled person will appreciate that the present disclosure is applicable to other utility supply networks, such as electricity, water and gas, in which case different measurement data would be required which is relevant to those utilities.

What is claimed is:

1. A computer-implemented method of determining a priority of an incident in a utility supply network, the method comprising:
receiving an indication of the incident in the utility supply network;
receiving subjective data relating to user perception of performance of the utility supply network; and
determining a priority of the incident based on the subjective data.

2. The method of claim 1, wherein the subjective data is associated with a cluster of users associated with the incident, wherein the cluster of users associated with the incident is based on users in a geographic area associated with the incident and/or users supplied by network equipment associated with the incident.

3. The method of claim 2, wherein the subjective data comprises status checks on the performance of the utility supply network by users of the cluster.

4. The method of claim 3, wherein the priority of the incident is based on either:
the number of users in the cluster submitting status checks; or
the number of users in the cluster submitting status checks as a proportion of the total number of users associated with the cluster, wherein the number of users associated with the cluster is the number of users typically supplied by network equipment associated with the incident or the number of users supplied by the network equipment at the time of the incident.

5. The method of claim 4, further comprising:
receiving outage data indicating a level of outage on the utility supply network; and
determining the priority of the incident based on the number of users in the cluster submitting status checks and the level of outage given by the outage information.

6. The method of claim 5, wherein the outage data indicates either: a known outage on the utility supply network and the priority is increased in response to the known outage; or the outage data indicates no known outage on the utility supply network and the priority is decreased in response to there being no known outage.

7. The method of claim 4, wherein determining the priority of the incident comprises comparing the number of users in the cluster submitting status checks against a plurality of thresholds, wherein the number of users in the cluster submitting status checks exceeding a given threshold of the plurality of thresholds assigns one of a plurality of priority levels to the incident, wherein the plurality of priority levels comprise a priority level for urgent incidents and priority level for incidents investigable during routine maintenance.

8. The method of claim 1, further comprising modifying the priority of the incident based on at least one of: accessibility of a site associated with the incident; the number and/or importance of users of the utility supply network predicted to be affected by the incident; and
the number of items of network equipment disrupted by the incident.

9. The method of claim 1, wherein the priority is determined by evaluating, using a decision-tree, one of more of: subjective data, objective data and outage data.

10. The method of claim 1, further comprising:
receiving objective data relating to measurements of the performance of the utility supply network; and
determining the priority of the incident based on the subjective data and the objective data.

11. The method of claim 10, wherein the priority of the incident is based on a level of disruption to the performance of the utility supply network indicated by the objective data.

12. The method of claim 11, wherein the priority of the incident is decreased in response to the objective data indicating a lower level of disruption and the priority of the incident is increased in response to the objective data indicating a higher level of disruption.

13. The method of claim 11, wherein the level of disruption is determined through comparison between the objective data and historical objective data.

14. The method of claim 13, wherein the historical objective data is for a time of day corresponding with the time of day associated with the incident.

15. The method of claim 1, wherein the incident is one of more of:
a fault, known problem or outage with the utility supply network or equipment connected to the utility supply network;
an alarm or warning associated with equipment connected to the utility supply network;
a maintenance event or an upgrade of equipment connected to the utility supply network;
a cluster of users requesting status checks on the performance of the utility supply network or submitting complaints about the performance of the utility supply network; and
a network measurement-derived indication of a problem with the utility supply network.

16. The method of claim 1, wherein the utility supply network is a communications network, such as a mobile communications network.

17. The method of claim 16, wherein measurements of the performance of the utility supply network comprise at least one of: signal strength received at a mobile device connected to the mobile communications network, transmitter output power, transmitted data rates, latency, voice quality, bit error rate, and SINAD.

18. A tool to determine a priority of an incident in a utility supply network, the tool comprising:
an input configured to receive an indication of the incident in the utility supply network and subjective data relating to user perception of performance of the utility supply network; and
a processor configured to determine a priority of the incident based on the subjective data.

19. A computer readable storage medium comprising instructions which when executed by a processor cause the processor to carry out a method according to claim 1.
